(19) United States
(12) Patent Application Publication
(10) Pub. No.: US 2026/0046707 A1
(43) Pub. Date: Feb. 12, 2026

(54) Efficient Distribution of Connection Configurations in a Radio Access Network (RAN)

(71) Applicant: Telefonaktiebolaget LM Ericsson (publ), Stockholm (SE)

(72) Inventors: John Power, County Westmeath (IE); Mathias Sintorn, Sollentuna (SE)

(21) Appl. No.: 19/105,087

(22) PCT Filed: Nov. 25, 2022
(86) PCT No.: PCT/EP2022/083281

§ 371 Date: Feb. 20, 2025

(51) Int. Cl. H04W 36/00

(52) U.S. Cl. CPC H04W 36/0058; H04W 36/00835

(57) ABSTRACT

Embodiments include methods for a first radio access network (RAN) node configured to serve one or more cells. Such methods include identifying a first cell served by a RAN node with which the first RAN node does not have a connection for communication and, in response to identifying the first cell, obtaining the following information from a tracking node associated with the RAN: an identifier of a second RAN node that serves the first cell, and an indication that a connection configuration for the identified second RAN node is available from one or more third RAN nodes. Such methods include obtaining the connection configuration for the second RAN node from one of the indicated third RAN nodes. Other embodiments include complementary methods for the tracking node and the second RAN node, as well as network nodes or functions configured to perform such methods.

### TECHNICAL FIELD

The present application relates generally to the field of communication networks, and more specifically to techniques for efficiently distributing inter-node connection configurations used by radio access network (RAN) nodes to other (e.g., peer) RAN nodes that require such information to setup connections.

### INTRODUCTION

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

FIG. 1 illustrates a high-level view of an exemplary 5G network architecture, consisting of a Next Generation Radio Access Network (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. Various other network functions (NFs) can be included in the 5GC 198, as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (e.g., NG, Xn, F1) the related TNL protocol and the functionality are specified. The TNL provides services for user plane transport and signaling transport.

The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. A DU (e.g., gNB-DUs 120, 130) is a decentralized logical node that hosts lower layer protocols and can include, depending on the functional split option, various subsets of the gNB functions. As such, each of the CUs and DUs can include various circuitry needed to perform their respective functions, including processing circuitry, transceiver circuitry (e.g., for communication), and power supply circuitry.

A gNB-CU connects to one or more gNB-DUs over respective F1 logical interfaces, such as interfaces 122 and 132 shown in FIG. 1. However, a gNB-DU can be connected to only a single gNB-CU, except for certain implementations that promote resiliency and/or redundancy. The gNB-CU and connected gNB-DU(s) are only visible to other gNBs and the 5GC as a gNB. In other words, the F1 interface is not visible beyond gNB-CU.

FIG. 2 shows an exemplary protocol stack for the Xn signaling or control plane (CP) interface between gNBs, also referred to herein as “Xn-C protocol stack”. The RNL portion at the top is based on the XnAP protocol, while the TNL portion at the bottom is based on Stream Control Transmission Protocol (SCTP) and Internet Protocol (IP). These transport protocols are above implementation-specific data link and physical layers. Since SCTP is a point-to-point protocol, each gNB has a separate Xn interface to each of the neighboring gNBs that it communicates with.

As specified in 3GPP TS 38.423 (17.2.0), the XnAP protocol for the Xn interface includes mobility procedures and global procedures. One of the global procedures is the Xn Setup procedure for establishing an Xn interface between two peer RAN nodes (e.g., gNBs). In this procedure, one of the RAN nodes sends an Xn Setup Request message that includes a complete (or partial, if supported) list of cells served by that node. If the Xn setup is accepted, the peer RAN node responds with an Xn Setup Response message that a complete (or partial, if supported) list of cells served by the peer RAN node.

Before performing an Xn Setup procedure with a peer RAN node, a RAN node can obtain an address of the peer RAN node in multiple ways. First, addresses of various peer RAN nodes can be manually configured in the RAN node's memory. Second, the RAN node can be triggered to obtain the address of a peer RAN node based one or more unrecognized cell identities from measurement reports of UEs served by the RAN node. The RAN node can send these cell identities to a domain name service (DNS) or an operational support system (OSS) associated with the 5G network, which responds with the associated address(es) of the peer RAN node(s) serving these cells. This second technique is often referred to as “automatic Xn establishment.”

### SUMMARY

Node addresses used for Xn establishment are typically manually configured in the address repository (e.g., DNS or OSS), which presents a single point of failure for automatic Xn establishment. Additionally, RAN nodes may be configured individually to allow or prohibit automatic Xn establishment from another RAN node. Even if a node obtains an address of a peer RAN node from the repository, there is no way other than trial-and-error for the RAN node to discover whether the peer RAN node allows automatic Xn establishment.

As such, when a new node serving various cells is added to a RAN, this can create an excess amount of signaling towards the address repository by RAN nodes attempting automatic Xn establishment, which may be futile if the new node does not allow this operation. This unnecessary signaling can cause over-dimensioning of network signaling resources and excessive network energy consumption.

Embodiments of the present disclosure address these and other problems, issues, and/or difficulties, thereby facilitating more efficient signaling between nodes (e.g., base stations, gNBs, eNBs, etc.) in a RAN.

Some embodiments include exemplary methods (e.g., procedures) for a first RAN node configured to serve one or more cells.

These exemplary methods can include identifying a first cell served by a RAN node with which the first RAN node does not have a connection for communication. These exemplary methods can also include, in response to identifying the first cell, obtaining the following information from a tracking node associated with the RAN: an identifier of a second RAN node that serves the first cell, and an indication that a connection configuration for the identified second RAN node is available from one or more third RAN nodes. These exemplary methods can also include obtaining the connection configuration for the second RAN node from one of the indicated third RAN nodes.

In some embodiments, the tracking node does not serve any cells in the RAN and/or does not store any connection configurations for nodes of the RAN. Rather, such operations are performed by RAN nodes, such as the first and second RAN nodes. In other embodiments, the tracking node is a RAN node that serves one or more cells, such as the first, second, or third RAN node.

Other embodiments include exemplary methods (e.g., procedures) for a second RAN node configured to serve one or more cells.

These exemplary methods can include performing a registration of the following with a tracking node associated with the RAN:
an identifier of the second RAN node,
a list of cells served by the second RAN node, and
a list of RAN nodes that store a connection configuration for the second RAN node, wherein the list of RAN nodes includes the identifier of the second RAN node.

These exemplary methods can also include subsequently providing the connection configuration for the second RAN node to a first RAN node, in response to a request that is based on the registration. These exemplary methods can also include selectively establishing a connection with the first RAN node based on the provided connection configuration.

In some embodiments, the tracking node does not serve any cells in the RAN and/or does not store any connection configurations for nodes of the RAN. Rather, such operations are performed by RAN nodes, such as the first and second RAN nodes. In other embodiments, the tracking node is a RAN node that serves one or more cells, such as the first, second, or third RAN node.

Other embodiments include exemplary methods (e.g., procedures) for a tracking node configured to track connection configurations for nodes of a RAN.

These exemplary methods can include receiving, from a third RAN node, a connection configuration registration indicating that the third RAN node stores a connection configuration for a second RAN node that serves a first cell. These exemplary methods can also include registering an association between the second RAN node and the third RAN node in accordance with the connection configuration registration. These exemplary methods can also include subsequently receiving, from a first RAN node, a query for a list of RAN nodes that store a connection configuration for a RAN node that serves a first cell. These exemplary methods can also include, based on the registered association, sending the following information to the first RAN node: an identifier of the second RAN node, and an indication that a connection configuration for the identified second RAN node is available from at least the third RAN node.

In some embodiments, the tracking node does not serve any cells in the RAN and/or does not store any connection configurations for nodes of the RAN. Rather, such operations are performed by RAN nodes, such as the first and second RAN nodes. In other embodiments, the tracking node is a RAN node that serves one or more cells, such as the first, second, or third RAN node.

Other embodiments include RAN nodes (e.g., base stations, eNBs, gNBs, ng-eNBs, etc.) and tracking nodes (e.g., base stations, eNBs, gNBs, ng-eNBs, CN nodes or NFs, NM/OAM/OSS/BSS nodes, host computing nodes, etc.) that are configured to perform operations corresponding to any of the exemplary methods described herein. Other embodiments also include non-transitory, computer-readable media storing computer-executable instructions that, when executed by processing circuitry associated with such RAN nodes and tracking nodes, configure the same to perform operations corresponding to any of the exemplary methods described herein.

These and other embodiments described herein provide various benefits and/or advantages. For example, by facilitating gNB distribution of Xn configurations, embodiments can reduce and/or eliminate possible inconsistencies present in Xn configurations distributed by centralized storage repositories, such as OSS and DNS. In a similar manner, embodiments can eliminate a single point of failure inherent with centralized storage repositories, since Xn configurations can be stored (and distributed) by multiple gNBs in a RAN. Additionally, by obtaining a target gNB's Xn configuration in advance of attempting Xn setup, a gNB can determine whether it is allowed to setup an Xn connection to the target gNB, and avoid doing so if not allowed. This can reduce unnecessary signaling load in the NG-RAN by eliminating repeated Xn setup requests that are futile.

These and other objects, features, and advantages of the present disclosure will become apparent upon reading the following Detailed Description in view of the Drawings briefly described below.

### BRIEF DESCRIPTION OF THE DRAWINGS

FIG. 1 shows an exemplary 5G network architecture.

FIG. 2 shows an exemplary protocol stack for the Xn signaling interface between RAN nodes (e.g., gNBs).

FIG. 3 shows an exemplary Network Function Virtualisation Management and Orchestration (NFV-MANO) architectural framework for a 3GPP-specified network.

FIG. 4 shows an exemplary setup procedure for an Xn interface between nodes (e.g., gNBs) of an NG-RAN.

FIG. 5 shows an exemplary automatic neighbor relations (ANR) function of a gNB in an NG-RAN.

FIG. 6 shows an exemplary RAN comprising six (6) gNBs that serve a plurality of cells in coverage area.

FIG. 7 shows the exemplary RAN of FIG. 6 after another gNB is added.

FIG. 8 shows a signaling diagram for an exemplary centralized connection configuration tracking architecture, according to some embodiments of the present disclosure.

FIG. 9 shows a signaling diagram for an exemplary decentralized or distributed connection configuration tracking architecture, according to other embodiments of the present disclosure.

FIG. 10 (which includes FIGS. 10A-B) shows an exemplary method (e.g., procedure) for a first RAN node configured to serve one or more cells, according to various embodiments of the present disclosure.

FIG. 11 shows an exemplary method (e.g., procedure) for a second RAN node configured to serve one or more cells, according to various embodiments of the present disclosure.

FIG. 12 (which includes FIGS. 12A-B) shows an exemplary method (e.g., procedure) for a tracking node configured to track connection configurations for RAN nodes, according to various embodiments of the present disclosure.

FIG. 13 shows a communication system according to various embodiments of the present disclosure.

FIG. 14 shows a UE according to various embodiments of the present disclosure.

FIG. 15 shows a network node according to various embodiments of the present disclosure.

FIG. 16 shows host computing system according to various embodiments of the present disclosure.

FIG. 17 is a block diagram of a virtualization environment in which functions implemented by some embodiments of the present disclosure may be virtualized.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (AMF), a user plane function (UPF), a Service Capability Exposure Function (SCEF), or the like.
Network Node: As used herein, a “network node” is any node that is part of the core network (e.g., a core network node discussed above) of a telecommunications network. Functionally, a network node is equipment capable, configured, arranged, and/or operable to communicate directly or indirectly with a wireless or wired device and/or with other network nodes or equipment in the telecommunications network, to enable and/or provide wireless or wired access to the telecommunication device, and/or to perform other functions (e.g., administration) in the telecommunications network.
Node: As used herein, the term “node” (without any prefix) can be any type of node that is capable of operating in or with a telecommunication network (including a RAN and/or a core network), including a radio access node (or equivalent term), core network node, or telecommunications device.
Service: As used herein, the term “service” refers generally to a set of data, associated with one or more applications, which is to be transferred via a network with certain specific delivery requirements that need to be fulfilled in order to make the applications successful.
Component: As used herein, the term “component” refers generally to any component needed for the delivery of a service. Examples of component are RANs (e.g., E-UTRAN, NG-RAN, or portions thereof such as eNBs, gNBs, base stations (BS), etc.), CNs (e.g., EPC, 5GC, or portions thereof, including all type of links between RAN and CN entities), and cloud infrastructure with related resources such as computation, storage. In general, each component can have a “manager”, which is an entity that can collect historical information about utilization of resources as well as provide information about the current and the predicted future availability of resources associated with that component (e.g., a RAN manager).

Note that the description given herein focuses on a 3GPP telecommunications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a telecommunications device or a network node may be distributed over a plurality of telecommunications devices and/or network nodes.

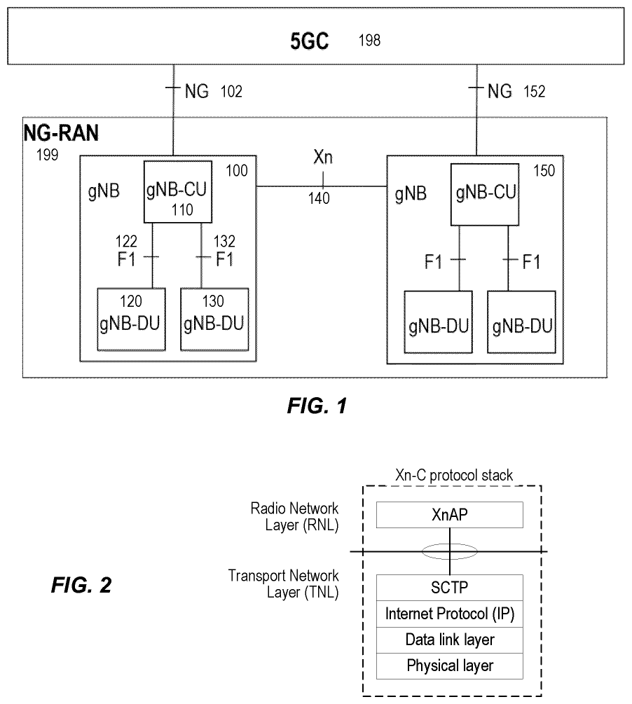

Conventionally, telecommunication equipment was provided as integrated software and hardware. More recently, virtualization technologies decouple software and hardware such that network functions (NFs) can be executed on commercial off-the-shelf (COTS) hardware. For example, mobile networks can include virtualized network functions (VNFs) and non-virtualized network elements (NEs) that perform or instantiate a NF using dedicated hardware. In the context of the exemplary 5G network architecture shown in FIG. 1, various NG-RAN nodes (e.g., CU) and various NFs in 5GC can be implemented as combinations of VNFs and NEs.

In general, a (non-virtual) NE can be considered as one example of a physical network function (PNF). From a high-level perspective, a VNF is equivalent to the same NF realized by an NE. However, the relation between NE and VNF instances depends on the relation between the corresponding NFs. A NE instance is 1:1 related to a VNF instance if the VNF contains the entire NF of the NE. Even so, multiple instances of a VNF may run on the same NF virtualization infrastructure (NFVI, e.g., cloud infrastructure, data center, etc.).

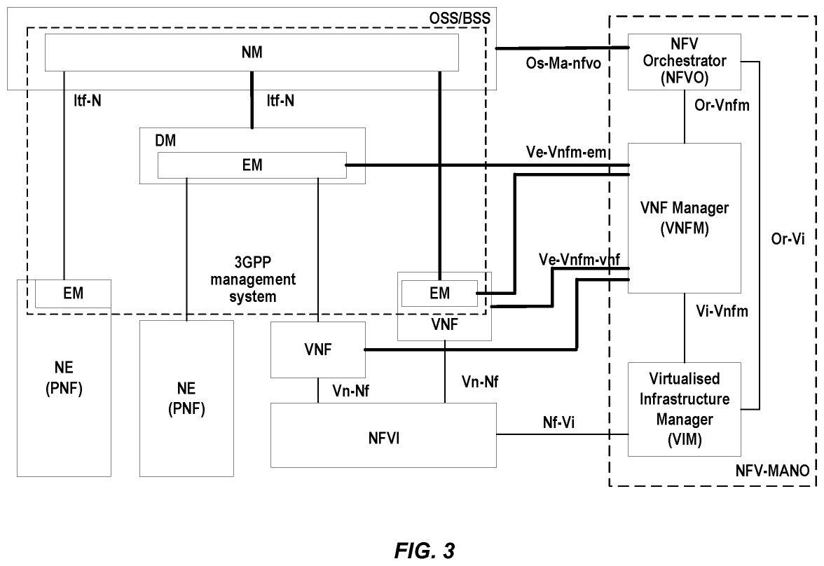

Both VNFs and NEs need to be managed in a consistent manner. To facilitate this, 3GPP specifies a Network Function Virtualisation Management and Orchestration (NFV-MANO) architectural framework. FIG. 3 shows an exemplary mobile network management architecture mapping relationship between NFV-MANO architectural framework and other parts of a 3GPP-specified network. The arrangement shown in FIG. 3 is described in detail in 3GPP TS 28.500 (v17.0.0) section 6.1, the entirety of which is incorporated herein by reference. Certain portions of this description are provided below for context and clarity.

The architecture shown in FIG. 3 includes the following entities, some of which are further defined in 3GPP TS 32.101 (v17.0.0):
Network Management (NM), which plays one of the roles of operation support system (OSS) or business support system (BSS) and is the consumer of reference point Os-Ma-nfvo;
Device Management (DM)/Element Management (EM), if the EM includes the extended functionality, it can manage both PNFs and VNFs;
NFV Orchestrator (NFVO);
VNF Manager (VNFM);
Virtualized infrastructure manager (VIM);
Itf-N, interface between NM and DM/EM;
Os-Ma-nfvo, reference point between OSS/BSS and NFVO;
Ve-Vnfm-em, reference point between EM and VNFM;
Ve-Vnfm-vnf, reference point between VNF and VNFM; and
NFVI, the hardware and software components that together provide the infrastructure resources where VNFs are deployed.

EM/DM is responsible for FCAPS (fault, configuration, accounting, performance, security) management functionality for a VNF on an application level and NE on a domain and element level. This includes:
Fault management for VNF and physical NE.
Configuration management for VNF and physical NE.
Accounting management for VNF and physical NE.
Performance measurement and collection for VNF and physical NE.
Security management for VNF and physical NE.
VNF lifecycle management (LCM), such as requesting LCM for a VNF by VNFM and exchanging information about a VNF and virtualized resources associated with a VNF.

As briefly described above in relation to FIG. 2, the control plane portion of the Xn interface between NG-RAN nodes (called “Xn-C”) includes an upper RNL portion based on the XnAP protocol and a lower TNL portion based on SCTP, IP, and implementation-specific data link and physical layers. Since SCTP is a point-to-point protocol, each gNB has a separate Xn interface to each of the neighboring gNBs that it communicates with.

Two SCTP endpoints have an “SCTP association” between them and the SCTP service reliably transfers user messages between the peers. An SCTP association has an association ID and includes multiple “streams”, each of which is a unidirectional logical channel. The initiator of an SCTP association (“client”) sends an SCTP packet with an INIT chunk which provides the other endpoint (“server”) with a list of the IP addresses through which the client can be reached, a verification tag that must appear in every packet the client sends in this association (validating the sender), the number of outbound streams the client is requesting, the number of inbound streams it can support, and an initial transmission sequence number.

The server replies with an INIT-ACK chunk containing its own list of IP addresses, initial sequence number, verification tag that must appear in every packet the server sends for this association, the number of outbound streams the server is requesting, the number of inbound streams it can support, and a state cookie that ensures the association is valid. The client then replies with a COOKIE-ECHO chunk and the server validates the cookie and replies with a COOKIE-ACK chunk. The COOKIE-ECHO and COOKIE-ACK messages can include user data (chunks) for more efficiency.

To summarize, each Xn connection between nodes is based on an SCTP association (also referred to as “TNL association”), which corresponds to (or is associated with) IP addresses used by the RAN nodes that are endpoints of the SCTP/TNL association. Thus, the terms “Xn address”, “TNL address”, and “transport layer address” are often used to refer to an IP address at which one of the nodes comprising a TNL association can be reached, or more generally an IP address at which a node can be reached for the purposes of forming a TNL association/Xn connection.

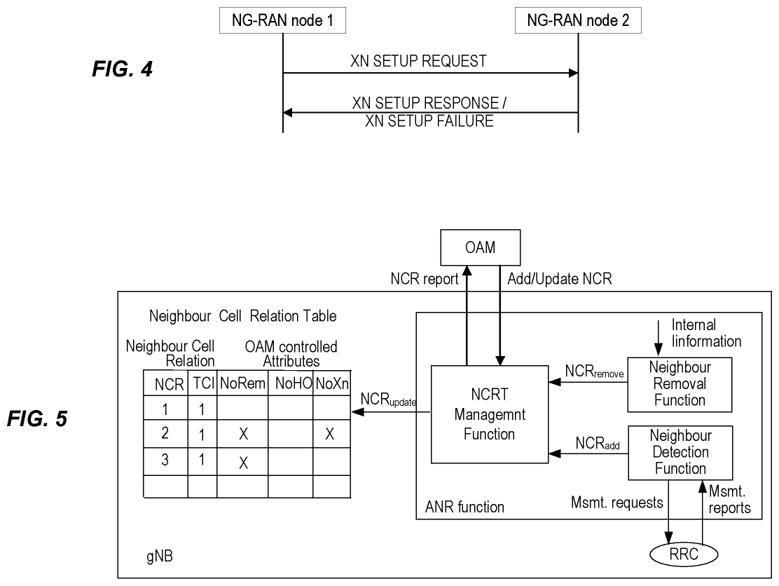

As specified in 3GPP TS 38.423 (v16.7.0), the upper-layer XnAP protocol includes mobility procedures and global procedures. One of the global procedures is the Xn Setup procedure for establishing an Xn interface between two peer RAN nodes (e.g., gNBs). FIG. 4 illustrates exemplary signaling for an Xn Setup procedure, in which NG-RAN node 1 sends an XN SETUP REQUEST message to NG-RAN node 2. The table below shows possible contents of the XN SETUP REQUEST message, which are further defined in 3GPP TS 38.423 (v17.2.0). Mandatory (“M”) information elements (IEs) include lists of NR and/or E-UTRA (LTE) cells served by NG-RAN node 1, as well as a list of neighbor NG-RAN nodes for NG-RAN node 1 (e.g., neighbor nodes to which NG-RAN node 1 has established Xn interfaces).

| IE/ | | | IE | Semantics |
|---|---|---|---|---|
| Group Name | Pres. | Range | type/ref | description |
| Message Type | M | | 9.2.3.1 | |
| Global NG-RAN Node ID | M | | 9.2.2.3 | |
| TAI Support List | M | | 9.2.3.20 | List of supported TAs and |
| | | | | associated characteristics. |
| AMF Region Information | M | | 9.2.3.83 | Contains a list of all the |
| | | | | AMF Regions to which the |
| | | | | NG-RAN node belongs. |
| List of Served Cells NR | | 0 . . . <maxnoofCellsinNG-RANnode> | | Contains a list of cells served |
| | | | | by the gNB. If a partial list of |
| | | | | cells is signalled, it contains |
| | | | | at least one cell per carrier |
| | | | | configured at the gNB |
| >Served Cell Information | M | | 9.2.2.11 | |
| NR | | | | |
| >Neighbour Information | O | | 9.2.2.13 | |
| NR | | | | |
| >Neighbour Information | O | | 9.2.2.14 | |
| E-UTRA | | | | |
| >Served Cell Specific | O | | 9.2.2.102 | |
| Info Request | | | | |
| List of Served Cells E- | | 0 . . . <maxnoofCellsinNG-RANnode> | | Contains a list of cells served |
| UTRA | | | | by the ng-eNB. If a partial |
| | | | | list of cells is signalled, it |
| | | | | contains at least one cell per |
| | | | | carrier configured at the ng- |
| | | | | eNB |
| >Served Cell Information | M | | 9.2.2.12 | |
| E-UTRA | | | | |
| >Neighbour Information | O | | 9.2.2.13 | |
| NR | | | | |
| >Neighbour Information | O | | 9.2.2.14 | |
| E-UTRA | | | | |
| Interface Instance | O | | 9.2.2.39 | |
| Indication | | | | |
| TNL Configuration Info | O | | 9.2.3.96 | |
| Partial List Indicator NR | O | | Partial List | Value “partial” indicates that |
| | | | Indicator | a partial list of cells is |
| | | | 9.2.2.46 | included in the List of Served |
| | | | | Cells NR IE. |
| Cell and Capacity | O | | 9.2.2.41 | Contains NR cell related |
| Assistance Information NR | | | | assistance information. |
| Partial List Indicator E- | O | | Partial List | Value “partial” indicates that |
| UTRA | | | Indicator | a partial list of cells is |
| | | | 9.2.2.46 | included in the List of Served |
| | | | | Cells E-UTRA. |
| Cell and Capacity | O | | 9.2.2.42 | Contains E-UTRA cell |
| Assistance Information E- | | | | related assistance |
| UTRA | | | | information. |
| Local NG-RAN Node | O | | 9.2.2.101 | |
| Identifier | | | | |
| Neighbour NG-RAN | | 0 . . . <maxnoofNeighbourNG-RANnodes> | | |
| Node List | | | | |
| >Global NG-RAN Node | M | | 9.2.2.3 | |
| ID | | | | |
| >Local NG-RAN Node | M | | 9.2.2.101 | |
| Identifier | | | | |

If NG-RAN node 2 can accept the Xn setup request from NG-RAN node 1, it responds with an XN SETUP RESPONSE message. This message can have similar content as shown in the table above, except from the perspective of NG-RAN node 2 rather than NG-RAN node 1. Specific fields of an XN SETUP RESPONSE message are further defined in 3GPP TS 38.423 (v17.2.0).

If NG-RAN node 2 cannot accept the Xn setup request from NG-RAN node 1, it responds with an XN SETUP FAILURE message. The message includes a Cause information element (IE) that indicates a reason for the failure. Various reasons that can be indicated by the Cause IE are defined in 3GPP TS 38.423 (v17.2.0). One of these reasons is that automatic Xn setup from another NG-RAN node is not allowed by NG-RAN node 2.

| IE/ | | | IE | Semantics |
|---|---|---|---|---|
| Group Name | Pres. | Range | type/ref | description |
| Message Type | M | | 9.2.3.1 | |
| Cause | M | | 9.2.3.2 | |
| Time To Wait | O | | 9.2.3.56 | |
| Criticality Diagnostics | O | | 9.2.3.3 | |
| Interface Instance Indication | O | | 9.2.2.39 | |
| Message Oversize Notification | O | | 9.2.2.45 | |

Before performing an Xn Setup procedure with a peer RAN node (e.g., NG-RAN node 2 in FIG. 4), a RAN node (e.g., NG-RAN node 1 in FIG. 4) can obtain an Xn address of a peer RAN node in multiple ways. First, Xn addresses of various peer RAN nodes can be manually configured in the RAN node's memory. Second, the RAN node can be triggered to obtain the address of a peer RAN node based one or more unrecognized cell identities from measurement reports of UEs served by the RAN node. The RAN node can send these cell identities to a domain name service (DNS) or an operational support system (OSS) associated with the 5G network, which responds with the associated address(es) of the peer RAN node(s) serving these cells. This second technique is often referred to as “automatic Xn establishment.”

Automatic Xn establishment is related to a function called “automatic neighbor relations” (ANR), which resides in each gNB and manages a Neighbour Cell Relation Table (NCRT). The ANR function includes a Neighbour Detection Function (NDF) that finds new neighbor cells (e.g., based on measurement reports from UEs) and adds them to the NCRT, and a Neighbour Removal Function (NRF) that removes outdated NCRs. NDF and NRF are not standardized by 3GPP (i.e., implementation specific).

FIG. 5 shows an exemplary ANR function of a gNB. Note that the ANR function includes an NCRT management function that is responsible for managing the NCRT for each cell based on inputs from NDR, NMR, and OAM, as well as providing NCR reports to OAM. Information exchanged during an Xn Setup procedure can be used to populate NCRTs for a gNB's source cells. Even so, NCRs are cell-to-cell relations while an Xn connection is set up between two gNBs. Also, NCRs are unidirectional while an Xn connection is bidirectional.

An NCR from a source cell to a target cell means that gNB controlling the source cell knows the global and physical IDs of the target cell e(.g., NR CGI/NR PCI or ECGI/PCI) and has an entry in its NCRT for the source cell that identifies the target cell. Additionally, each NCRT entry includes various attributes associated with the corresponding target cell, which are defined by OAM or set to default values by the gNB associated with the NCRT source cell. The NCRT shown in FIG. 5 includes some exemplary attributes for target cells. In addition to setting target cell attributes, OAM can add and delete NCRs from an NCRT.

Typically, RAN node addresses used for Xn establishment are manually configured in the repository (e.g., DNS or OSS). Additionally, RAN nodes may be configured individually to allow or prohibit automatic Xn establishment from another RAN node. Even if a node obtains an address of a peer RAN node from the repository, there is no way other than trial-and-error for the RAN node to discover whether the peer RAN node allows automatic Xn establishment.

As such, when a new node serving various cells is added to a RAN, this can create an excess amount of signaling, towards the address repository and the new RAN node, by RAN nodes attempting automatic Xn establishment. Even so, this signaling is unnecessary if the new RAN node does not allow Xn establishment. This unnecessary signaling can cause over-dimensioning of network signaling resources and excessive network energy consumption.

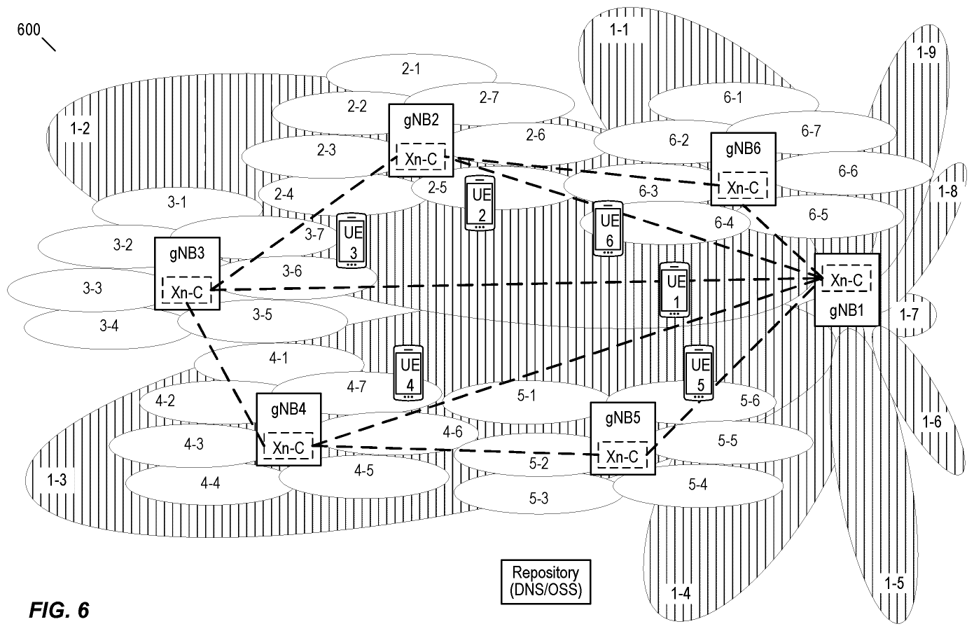

To illustrate this problem, FIG. 6 shows an exemplary RAN comprising six (6) gNBs that serve a plurality of cells in a coverage area. In particular, gNBs 2-6 serve respective small coverage areas while gNB 1 serves a large coverage area that overlaps with the small coverage areas of gNBs 2-6. In this sense, gNBs 2-6 can be considered micro gNBs and gNB 1 can be considered a macro gNB. Each of gNBs 2-6 serves a small number (e.g., six or seven) of cells in their small coverage areas, while gNB 1 serves a much larger number of cells throughout its large coverage (although only nine are shown in FIG. 6). As a specific deployment example, each of gNBs 2-6 can serve a shopping mall, an office building, an apartment complex, etc. while gNB 1 serves a metropolitan area that includes the shopping mall, the office building, the apartment complex, etc.

Each of the gNBs in FIG. 6 includes an Xn-C protocol stack such as shown in FIG. 2, which it uses for point-to-point communication via Xn connections with other neighboring gNBs. For example, gNB3 has point-to-point Xn connections with gNBs 1, 2, and 4 in the exemplary arrangement. These Xn connections may have been setup using the procedure shown in FIG. 4.

FIG. 6 also shows that various gNBs serve UEs via their respective cells. In particular gNB1 serves UE1 via cell 1-2, gNB2 serves UE2 via cell 2-5, gNB3 serves UE3 via cell 3-6, gNB4 serves UE4 via cell 4-7, gNB5 serves UE5 via cell 5-6, and gNB6 serves UE6 via cell 6-4. While being served by their respective cells, the UEs can perform measurements of neighbor cells and report these measurements to the respective gNBs serving these cells. As a specific example, UE3 can detect and measure signals from neighbor cell 3-7 served by gNB3, neighbor cell 2-4 served by gNB2, and neighbor cell 1-2 served by gNB1.

Additionally, FIG. 6 shows a repository for Xn address information for gNBs comprising the RAN shown in FIG. 6. For example, the repository may be a DNS system or an OAM system. As briefly explained above, when a gNB receives a UE measurement report for a previously unknown cell, the gNB can query the repository using a cell identifier for the cell. The repository will return the Xn address for the RAN node (e.g., gNB or eNB) that serves the cell associated with the provided identifier. Although this conventional approach provides the needed functionality, one drawback is that the repository is a single point of failure for automatic Xn establishment

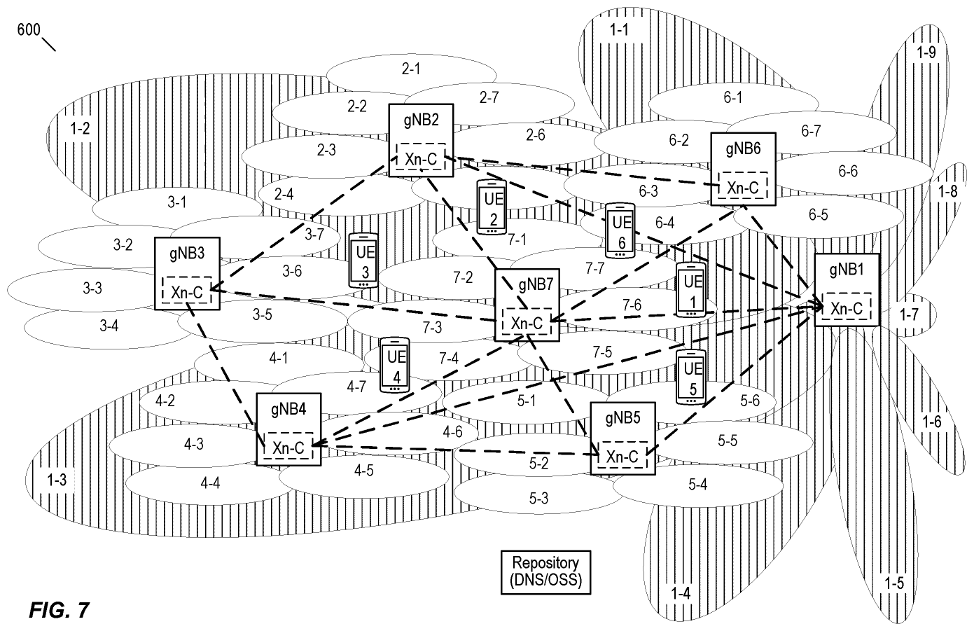

FIG. 7 shows the exemplary RAN of FIG. 6 after another gNB is added. In particular, gNB7 that services cells 7-1 to 7-7 is added in an area that overlaps with the coverage of cells 1-2 and 1-3 served by gNB1 and that is in between the coverages of the cells served by gNBs 2-6. For example, gNB7 could be added to offload some of the traffic previously carried by cells 1-2 and 1-3.

The UEs continue performing measurements of neighbor cells and reporting these measurements to their respective serving gNBs. After gNB7 is added, however, these measurement reports will contain measurements of various cells 7-1 to 7-7 served by gNB7. As some specific examples, UE3 and UE4 will now detect and measure signals from neighbor cells 7-2 and 7-4, respectively, served by gNB3 —in addition to the neighbor cells previously detected.

After gNBs 1-6 receive these measurement reports with these new cells, they will query the repository for corresponding Xn address information for gNB7. This is a considerable amount of signaling traffic towards the repository. After obtaining the Xn address for gNB7, each of gNBs 1-6 will attempt an Xn Setup procedure towards gNB7, without knowing whether gNB7 even accepts Xn establishment requests from all gNBs (as shown in FIG. 7) or only a particular group of gNBs, or whether gNB7 prohibits all Xn establishment requests from other gNBs. Depending on this unknown, there can be a considerable amount of unnecessary signaling traffic attempting to setup Xn connections with newly added gNB7.

Typically, signaling, CPU, and memory resources of micro gNBs (or other nodes serving small coverage areas) are limited in comparison to macro gNB resources. This can reduce the per-gNB deployment cost, which balances against the larger number of micro gNBs that must be deployed to cover a given area (e.g., as compared to macro gNBs). However, the excess signaling caused by unnecessary Xn setup procedures can severely tax the limited signaling, CPU, and memory resources of micro gNBs. More generally, this excess signaling causes excessive network energy consumption and over-dimensioning of signaling resources, thereby negating other advantages of micro gNB deployment.

There are various reasons why these problems are expected to be worse in future deployments. First, many future NR deployments will be in higher-frequency (e.g., millimeter wave) spectrum in which signal propagation is more limited. Thus, a greater number of smaller cells will be needed for a given coverage area, which will require a greater number of gNBs. Second, it is expected that integrating new NR deployments with existing (or legacy) vendor implementations (e.g., for LTE) will increase the need for exchanging Xn configuration information between nodes.

Third, many future NR deployments are expected to follow cloud-native RAN architectures that implement RAN functions (e.g., gNB CU and DU) in generic computing platforms (including hardware acceleration) using cloud-native software principles such as microservices, containers, and virtualization. It is expected that gNB functionality will be more centralized, resulting in a higher concentration of signaling associated with setup of Xn connections that may be unnecessary.

Fourth, network energy saving is expected to become more important. For example, an NG-RAN may dynamically power-down certain gNBs or operate these gNBs in a reduced-energy state. In such case, the process for setting up Xn connections may need to be repeated every time a gNB is powered-up or returned to a normal energy state.

Accordingly, embodiments of the present disclosure address these and other problems, issues, and/or difficulties by techniques for efficient sharing and/or distribution of Xn configuration information among NG-RAN nodes (e.g., gNBs).

Some embodiments are based on a centralized Xn (or connection) configuration tracking architecture can be employed. Each gNB registers its served cells and its Xn configuration with a centralized tracking node. This registration can be considered a “torrent” or “seed.” Each gNB also registers an associated address (e.g., as a torrent endpoint) from which its Xn configuration can be obtained by other gNBs. As other gNBs obtain copies of a gNB's Xn configuration, they also register their copies with the tracking node in a similar manner. The tracking node can provide to querying gNBs an indication of gNBs (e.g., torrent endpoints) that are registered as holding an Xn configuration for a gNB serving a cell of interest. When a gNB updates its Xn configuration, it also notifies the tracking node of this update. The tracking node then informs all gNBs registered as holding copies of that Xn configuration about the update, and these registered gNBs can obtain the updated Xn configuration in a similar manner as they obtained the original Xn configuration.

Other embodiments are based on a decentralized or distributed Xn (or connection) configuration tracking architecture. Put differently, each NG-RAN node (e.g., gNB) can operate as a distributed tracking node for Xn configurations (although it is not necessary that all gNBs operate as tracking nodes). Each gNB registers its served cells and its Xn configuration with peer gNBs operating as tracking node, along with an associated address from which Xn configuration can be obtained by other gNBs. As other gNBs obtain copies of a gNB's Xn configuration, they also register their copies with the peer gNB tracking nodes in a similar manner. Each peer gNB tracking node can provide to querying gNBs an indication of gNBs (e.g., torrent endpoints) that are registered as holding an Xn configuration for a gNB serving a cell of interest. When a gNB updates its Xn configuration, it also notifies (at least) the gNBs registered as holding the Xn configuration of this update. These registered gNBs can obtain the updated Xn configuration in a similar manner as they obtained the original Xn configuration.

Embodiments described herein provide various benefits and/or advantages. For example, by facilitating gNB distribution of Xn configurations, embodiments can reduce and/or eliminate possible inconsistencies present in Xn configurations distributed by centralized storage repositories, such as OSS and DNS. In a similar manner, embodiments can eliminate a single point of failure inherent with centralized storage repositories, since Xn configurations can be stored (and distributed) by multiple gNBs in a RAN. Additionally, by obtaining a target gNB's Xn configuration in advance of attempting Xn setup, a gNB can determine whether it is allowed to setup an Xn connection to the target gNB, and avoid doing so if not allowed. This can reduce unnecessary signaling load in the NG-RAN by eliminating repeated Xn setup requests that are futile.

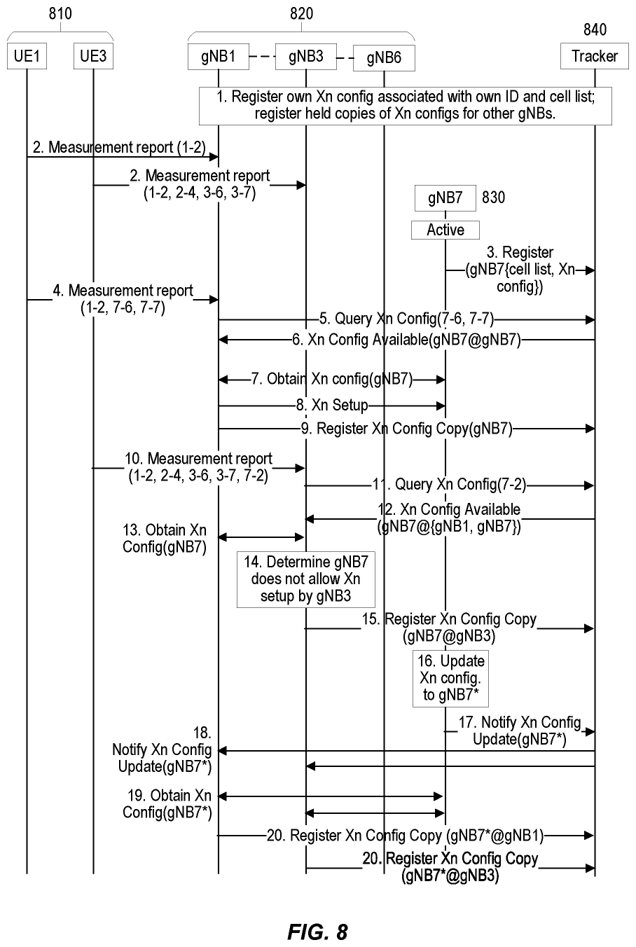

FIG. 8 shows a signaling diagram for an exemplary centralized connection configuration tracking architecture, according to some embodiments of the present disclosure. In particular, the example shown in FIG. 8 is based on the exemplary network arrangement of seven (7) gNBs shown in FIG. 7 and discussed above. More specifically, FIG. 8 shows signaling between a centralized tracking node (tracker 840) and gNBs 1-7 shown in FIG. 7, denoted with references numbers 820 (collectively for gNBs 1-6) and 830 (for gNB7). Although the operations shown in FIG. 8 are given numerical labels, this is done to facilitate explanation rather than to require or imply a sequential order, unless stated to the contrary below. Furthermore, the message names shown in FIG. 8 are merely exemplary.

In operation 1, each of gNBs 1-6 registers its own Xn configuration in association with its own gNB ID and (at least partial) list of served cells (e.g., cell IDs) with the tracker. Each gNB also registers any copies of Xn configurations for other. For example, gNB3 registers its own Xn configuration, gNB ID, and list of served cells 3-1 through 3-7 with the tracker and declares that it holds a copy of the Xn configurations for gNBs 1, 2, and 4, with which gNB3 has established Xn connections as shown in FIG. 6. The tracker stores or registers respective associations between the gNBs and the Xn configurations that they store.

In operation 2, UE1 (810) sends a measurement report to its serving gNB1, with measurements of cell 1-2. Likewise, UE3 (810) sends a measurement report to its serving gNB3, with measurements of cell 1-2 (served by gNB1), cell 2-4 (served by gNB2), and cells 3-6 and 3-7 (served by gNB3). After these measurement reports, gNB7 is activated and begins transmitting in its cells 7-1 to 7-7. In operation 3, gNB7 registers its own Xn configuration, gNB ID, and list of served cells 7-1 to 7-7 with the tracker. For example, gNB7 can provide a hash value of its Xn configuration during the registration.

Subsequently, in operation 4 UE1 sends another measurement report to its serving gNB1, now including measurements of cell 1-2 (served by gNB1) and cells 7-6 and 7-7 served by gNB7. In operation 5, after determining that it does not recognize cells 7-6 and 7-7 and/or does not have an Xn connection to a gNB serving these cells, gNB1 sends a Query Xn Config message to the tracker, requesting Xn configuration(s) for the gNB(s) serving cells 7-6 and 7-7. In operation 6, the tracker checks its registrations for the cell IDs included in the query, determines that they are served by gNB7, and responds with a Xn Config Available message that includes the ID of serving gNB7 and an indication that the Xn configuration for gNB7 is held only by gNB7 (denoted gNB7@gNB7). This indication can be a torrent endpoint address associated with gNB7, from which the Xn configuration for gNB7 can be obtained.

In operation 7, gNB1 obtains the Xn configuration for gNB7, e.g., from the torrent endpoint address received in operation 6. In operation 8, gNB1 initiates an Xn Setup procedure towards gNB7, in accordance with the obtained Xn configuration. For example, the Xn configuration may include one or more of the following lists:
a first list of one or more RAN nodes that are blocked from establishing a connection with the second RAN node (“blocked list”);
a second list of one or more RAN nodes that are allowed to establish a connection with the second RAN node (“allowed list”); and
a third list of one or more RAN nodes that are blocked from using an established connection with the second RAN node for handover of UEs to target cells served by the second RAN node (“noHO list”).

In such case, gNB1 may initiate Xn Setup towards gNB7 based on the following conditions:
the first RAN node is not a member of the blocked list or is a member of the allowed list, and
the first RAN node is not a member of the noHO list.

If these conditions are not true, then gNB1 refrains from initiating Xn Setup towards gNB7. In the case shown in FIG. 8, the conditions are true so gNB7 initiates the Xn Setup in operation 8. In operation 9, gNB1 registers with the tracker that it holds a copy of the Xn configuration for gNB7, which it obtained in operation 7. The tracker updates gNB1's registration to associate this newly provided information.

In operation 10, UE3 sends another measurement report to its serving gNB3, now including measurements of cell 1-2 (served by gNB1), cell 2-4 (served by gNB2), cells 3-6 and 3-7 (served by gNB3), and cell 7-2 served by gNB7. In operation 11, after determining that it does not recognize cell 7-2 and/or does not have an Xn connection to a gNB serving this cell, gNB3 sends a Query Xn Config message to the tracker, requesting an Xn configuration for the gNB serving cell 7-2. In operation 12, the tracker checks its registrations for the cell ID included in the query, determines that it is served by gNB7, and responds with a Xn Config Available message that includes the ID of serving gNB7 and an indication that the Xn configuration for gNB7 is held by gNB1 and gNB7 (denoted gNB7@{gNB1, gNB7}). This indication can be torrent endpoint addresses associated with gNB1 and gNB7, from which the Xn configuration for gNB7 can be obtained.

In operation 13, gNB3 obtains the Xn configuration for gNB7, e.g., from the torrent endpoint address received in operation 12. In operation 14, gNB3 checks the one or more lists included in the Xn configuration for gNB7 and determines that the conditions are not true, e.g., that gNB3 is on the blocked list. In such case, gNB3 refrains from Xn Setup towards gNB7 but in operation 15 registers with the tracker that it holds a copy of the Xn configuration for gNB7, which it obtained in operation 13.

Subsequently, in operation 16 gNB7 updates its Xn configuration, with the updated configuration denoted gNB7* in FIG. 8. For example, gNB7 can update a blocked list, an allowed list, a noHO list, etc. As another example, gNB7 may have added one or more redundant transport links (e.g., TNL associations) for Xn connections with other RAN nodes. If transport-layer address information is included in the Xn configuration, then the gNB can update it upon adding the redundant transport links.

In operation 17, gNB7 sends to the tracker a Notify Xn Config Update message that indicates gNB7 Xn configuration has been updated to gNB7*. For example, gNB7 can provide a hash value of configuration gNB7*, which will be different than a hash value of the Xn configuration previously registered with the tracker in operation 3. The tracker updates the registered association between gNB7 and its updated Xn configuration gNB7* and identifies that gNBs 1 and 3 also hold copies of the now-outdated Xn configuration for gNB7. In operation 18, the tracker forwards the Notify Xn Config Update message to gNBs 1 and 3, indicating that the Xn configuration for gNB7 has been updated (e.g., by including the updated hash value).

Based on the information received in operation 18 and the previous indications that the Xn configuration for gNB7 is available from gNB7, gNBs 1 and 3 obtain new Xn configuration gNB7* from gNB7 in operation 19. In operation 20, gNBs 1 and 3 register their newly obtained Xn configurations gNB7* with the tracker, which updates the registered associations between these gNBs and the Xn configurations that they store.

Note that operations 19-20 may not immediately follow operation 18, or may not be performed at all. In other words, gNBs 1 and/or 3 may forego querying gNB7 for updated Xn configuration gNB7* until some later time as needed. Alternately, gNBs 2 and/or 3 may refrain from querying gNB7 for updated Xn configuration gNB7*. Put differently, it is left to individual discretions of gNBs 1 and 3 whether and/or when to query gNB7 for updated Xn configuration gNB7*.

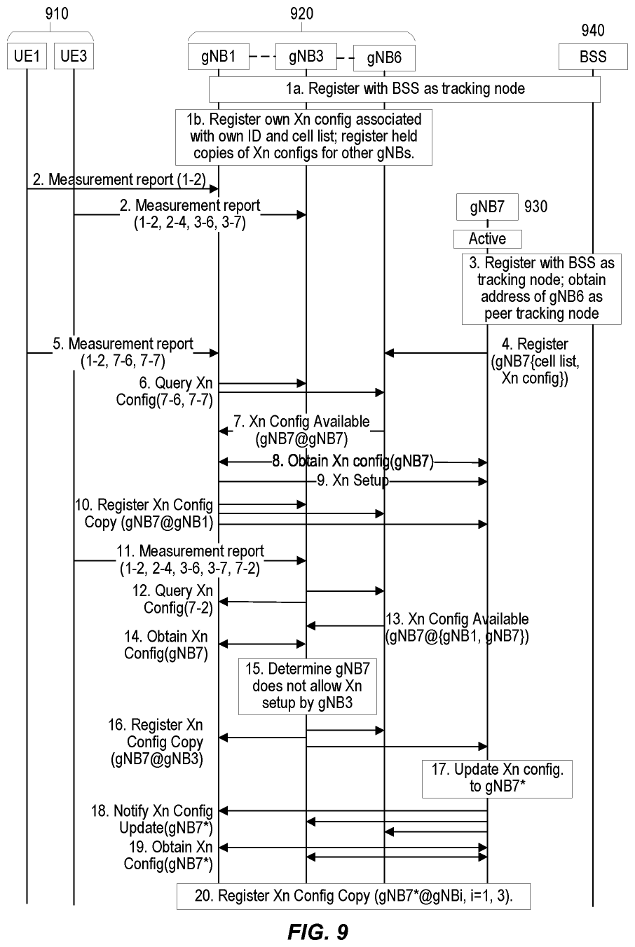

FIG. 9 shows a signaling diagram for an exemplary decentralized or distributed connection configuration tracking architecture, according to other embodiments of the present disclosure. More specifically, FIG. 9 shows signaling between a bootstrapping server (BSS 940) and gNBs 1-7 shown in FIG. 7, denoted with references numbers 920 (collectively for gNBs 1-6) and 930 (for gNB7). Although the operations shown in FIG. 9 are given numerical labels, this is done to facilitate explanation rather than to require or imply a sequential order, unless stated to the contrary below. Furthermore, the message names shown in FIG. 9 are merely exemplary.

The distributed connection configuration tracking architecture illustrated by FIG. 9 are based on a technique sometimes referred to as “distributed hash table” (or DHT). In this technique, individual gNBs can operate as trackers without the need for a centralized tracking node as in FIG. 8. However, the technique shown in FIG. 9 requires that when each gNB is introduced to the RAN for the first time, it must be able to find at least one peer gNB with which to register its Xn configuration. This is provided by the BSS shown in FIG. 9

More specifically, in operation 1a, each of gNBs 1-6 registers with the BSS as a tracking node. For example, the address of the BSS can be pre-configured in each gNB prior to or during initialization and startup. In some cases, one or more of gNBs 1-6 may also obtain from the BSS during registration an address of another registered gNB, to which an Xn configuration registration can be performed.

In operation 1b, each of gNBs 1-6 registers its own Xn configuration in association with its own gNB ID and (at least partial) list of served cells (e.g., cell IDs) with its peer gNBs operating as tracking nodes. Each gNB also registers any copies of Xn configurations for other gNBs. For example, gNB3 registers its own Xn configuration, gNB ID, and list of served cells 3-1 through 3-7 with the other gNBs and declares that it holds a copy of the Xn configurations for gNBs 1, 2, and 4, with which gNB3 has established Xn connections as shown in FIG. 6. The tracking nodes store or register respective associations between the gNBs and the Xn configurations that they store.

In operation 2, UE1 (810) sends a measurement report to its serving gNB1, with measurements of cell 1-2. Likewise, UE3 (810) sends a measurement report to its serving gNB3, with measurements of cell 1-2 (served by gNB1), cell 2-4 (served by gNB2), and cells 3-6 and 3-7 (served by gNB3). After these measurement reports, gNB7 is activated and begins transmitting in its cells 7-1 to 7-7. In operation 3, gNB7 registers with BSS as a tracking node and obtains from the BSS an address of one of the RAN nodes configured to operate as a tracking node, to which the registration is performed. In this example, gNB7 obtains the address of gNB6.

In operation 4, gNB7 registers its own Xn configuration, gNB ID, and list of served cells 7-1 to 7-7 with gNB6 operating as a tracking node. For example, gNB7 can provide a hash value of its Xn configuration during the registration.

Subsequently, in operation 5 UE1 sends another measurement report to its serving gNB1, now including measurements of cell 1-2 (served by gNB1) and cells 7-6 and 7-7 served by gNB7. In operation 6, after determining that it does not recognize cells 7-6 and 7-7 and/or does not have an Xn connection to a gNB serving these cells, gNB1 sends a Query Xn Config message to the tracking nodes (e.g., gNBs 2-6), requesting Xn configuration(s) for the gNB(s) serving cells 7-6 and 7-7. In operation 7, the tracking nodes check their respective registrations for the cell IDs included in the query; gNB6 determines (e.g., based on the registration in operation 4) that these are served by gNB7 and responds with an Xn Config Available message that includes the ID of serving gNB7 and an indication that the Xn configuration for gNB7 is held only by gNB7 (denoted gNB7@gNB7). This indication can be a torrent endpoint address associated with gNB7, from which the Xn configuration for gNB7 can be obtained.

In operation 8, gNB1 obtains the Xn configuration for gNB7, e.g., from the torrent endpoint address received in operation 7. In operation 9, gNB1 initiates an Xn Setup procedure towards gNB7, in accordance with the obtained Xn configuration. For example, the Xn configuration may include one or more of the blocked list, allowed list, and noHO list described above in relation to FIG. 8. In such case, gNB1 may initiate Xn Setup towards gNB7 based on the following conditions:
the first RAN node is not a member of the blocked list or is a member of the allowed list, and
the first RAN node is not a member of the noHO list.

If these conditions are not true, then gNBT refrains from initiating Xn Setup towards gNB7. In the case shown in FIG. 9, the conditions are true so gNB7 initiates the Xn Setup in operation 8. In operation 10, gNBT registers with the tracking nodes (e.g., gNBs 2-7) that it holds a copy of the Xn configuration for gNB7, which it obtained in operation 8. The tracking nodes update their respective registrations for gNBT to associate this newly provided information.

In operation 11, UE3 sends another measurement report to its serving gNB3, now including measurements of cell 1-2 (served by gNB1), cell 2-4 (served by gNB2), cells 3-6 and 3-7 (served by gNB3), and cell 7-2 served by gNB7. In operation 12, after determining that it does not recognize cell 7-2 and/or does not have an Xn connection to a gNB serving this cell, gNB3 sends a Query Xn Config message to the tracking nodes (e.g., gNBs 1-2 and 4-6), requesting an Xn configuration for the gNB serving cell 7-2. In operation 13, the tracking nodes checks their respective registrations for the cell ID included in the query; gNB6 determines that it is served by gNB7 and responds with a Xn Config Available message that includes the ID of serving gNB7 and an indication that the Xn configuration for gNB7 is held by gNB1 and gNB7 (denoted gNB7@{gNB1, gNB7}). This indication can be torrent endpoint addresses associated with gNB1 and gNB7, from which the Xn configuration for gNB7 can be obtained.

In operation 14, gNB3 obtains the Xn configuration for gNB7 from gNB1, e.g., from the torrent endpoint address received in operation 12. In operation 15, gNB3 checks the one or more lists included in the Xn configuration for gNB7 and determines that the conditions are not true, e.g., that gNB3 is on the blocked list. In such case, gNB3 refrains from Xn Setup towards gNB7 but in operation 16 registers with the tracking nodes (e.g., gNBs 1-2 and 4-7) that it holds a copy of the Xn configuration for gNB7, which it obtained in operation 14.

Subsequently, in operation 17 gNB7 updates its Xn configuration, with the updated configuration denoted gNB7* in FIG. 9. For example, gNB7 can update a blocked list, an allowed list, a noHO list, etc. As another example, gNB7 may have added one or more redundant transport links (e.g., TNL associations) for Xn connections with other RAN nodes. If transport-layer address information is included in the Xn configuration, then the gNB can update it upon adding the redundant transport links.

In operation 18, gNB7 sends to the tracking nodes (e.g., gNBs 1-6) a Notify Xn Config Update message that indicates gNB7 Xn configuration has been updated to gNB7*. For example, gNB7 can provide a hash value of configuration gNB7*, which will be different than a hash value of the Xn configuration previously registered with the tracking node(s) in operation 4. The tracking nodes update their respective registered associations between gNB7 and its updated Xn configuration gNB7*.

Based on the notification received in operation 18 and the previous indications that the Xn configuration for gNB7 is available from gNB7, gNBs 1 and 3 obtain new Xn configuration gNB7* from gNB7 in operation 19. In operation 20, gNBs 1 and 3 register their newly obtained Xn configurations gNB7* with the tracking nodes, which update their respective registered associations between gNBs 1/3 and the Xn configurations that gNBs 1/3 store.

Note that operations 19-20 may not immediately follow operation 18, or may not be performed at all. In other words, gNBs 1 and/or 3 may forego obtaining updated Xn configuration gNB7* until some later time as needed. Alternately, gNBs 1 and/or 3 may refrain from obtaining updated Xn configuration gNB7*. Put differently, it is left to individual discretions of gNBs 1 and 3 whether and/or when to obtain updated Xn configuration gNB7*.

Note that the exemplary decentralized architecture scenario shown in FIG. 9 is somewhat simplified compared to actual RAN deployments. In the example, all gNBs know which peer gNBs store which Xn configurations based on the initial registration in operation 1 and updates in operations 10, 16, and 20. In actual RAN deployments, however, there will be many more gNBs and each gNB will not have complete knowledge of which peer gNBs store which Xn configurations. Thus, a gNB may need to start by sending a query to nearest neighbor gNBs and, if unsuccessful, to other gNBs more distant. As a specific example in the context of FIG. 9 operation 6, gNB1 can initially query gNB3 for Xn configuration(s) associated with cells 7-6/7-7 and, if unsuccessful, then query gNB6.

The various messages between peer gNBs in FIGS. 8-9 and between gNBs and the tracker in FIG. 8 can be implemented by various protocols running on top of any appropriate transport layer. For example, the various messages shown in FIGS. 8-9 can be implemented in a protocol that runs on top of the TNL protocols shown in FIG. 2, such as the XnAP protocol or in a protocol newly defined for the purpose of connection configuration distribution. Alternately, the various messages shown in FIGS. 8-9 can be implemented in a protocol that runs on top of the transport layer of the NG interface between NG-RAN nodes and 5GC, such as in FIG. 1. Alternately, when the tracker is deployed in OSS/BSS, the messages between gNBs and the tracker can be part of a protocol associated with reference point Os-Ma-nfvo, such as described above in relation to FIG. 3.

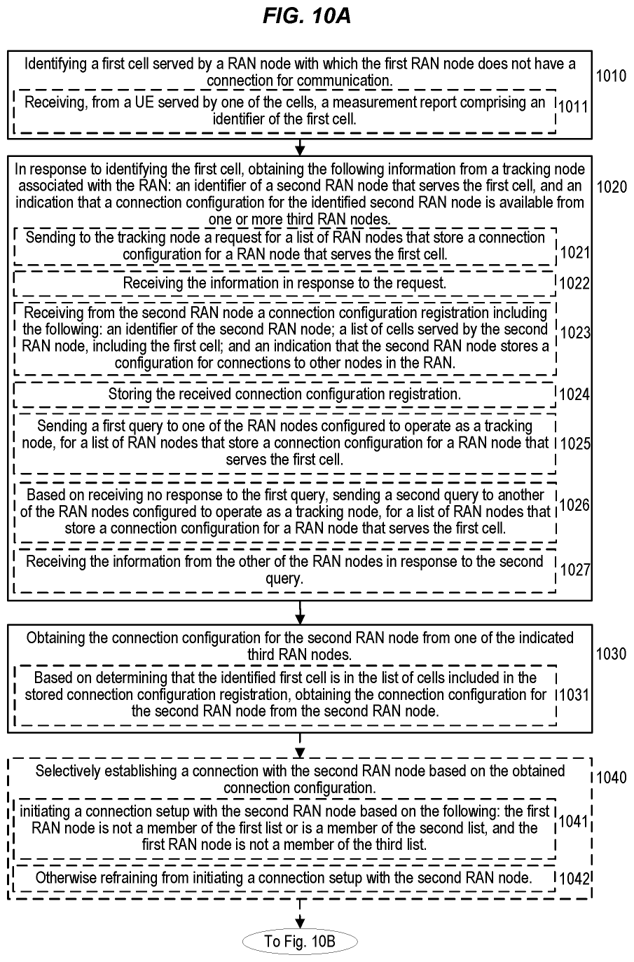

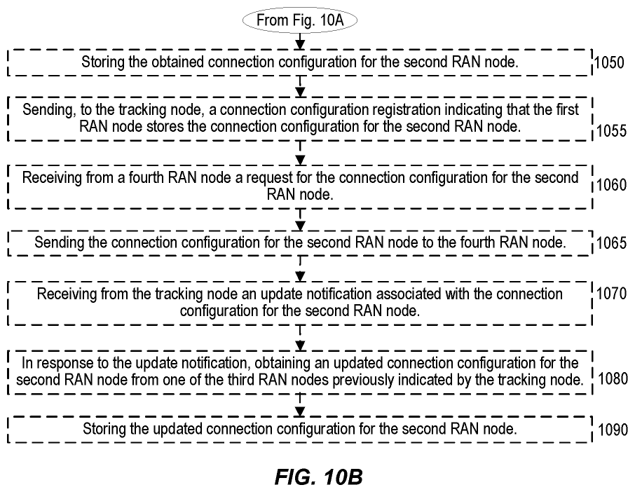

The embodiments described above can be further illustrated with reference to FIGS. 10-12, which depict exemplary methods (e.g., procedures) for a first RAN node, a second RAN node, and a tracking node, respectively. Put differently, various features of the operations described below correspond to various embodiments described above. The exemplary methods shown in FIGS. 10-12 can be used cooperatively (e.g., with each other and with other procedures described herein) to provide benefits, advantages, and/or solutions to problems described herein. Although the exemplary methods are illustrated in FIGS. 10-12 by specific blocks in particular orders, the operations corresponding to the blocks can be performed in different orders than shown and can be combined and/or divided into blocks and/or operations having different functionality than shown. Optional blocks and/or operations are indicated by dashed lines.

In the context of FIGS. 10-12, the term “tracking node” is used generically to mean any network node that tracks connection configuration storage, with specific embodiments of “tracking nodes” mentioned at various points in the following description.

FIG. 10 (which includes FIGS. 10A-B) illustrates an exemplary method (e.g., procedure) for a first RAN node configured to serve one or more cells, according to various embodiments of the present disclosure. The exemplary method shown in FIG. 10 can be performed by any appropriate RAN node (e.g., base station, eNB, gNB, ng-eNB, etc.) such as described elsewhere herein.

The exemplary method can include the operations of block 1010, where the first RAN node can identify a first cell served by a RAN node with which the first RAN node does not have a connection for communication. The exemplary method can also include the operations of block 1020, where in response to identifying the first cell, the first RAN node can obtain the following information from a tracking node associated with the RAN: an identifier of a second RAN node that serves the first cell, and an indication that a connection configuration for the identified second RAN node is available from one or more third RAN nodes. The exemplary method can also include the operations of block 1030, where the first RAN node can obtain the connection configuration for the second RAN node from one of the indicated third RAN nodes.

In some embodiments, obtaining the information from the tracking node in block 1020 can include the operations of sub-blocks 1021-1022, where the first RAN node can send to the tracking node a request for a list of RAN nodes that store a connection configuration for a RAN node that serves the first cell, and receive the information in response to the request. FIG. 8 operations 5-6 and FIG. 9 operations 6-7 are examples of the operations of sub-blocks 1021-1022.

In some embodiments, identifying the first cell in block 1010 includes the operations of sub-block 1011, where the first RAN node can receive, from a UE served by one of the cells (i.e., a cell served by the first RAN node), a measurement report comprising an identifier of the first cell. FIG. 8 operation 4 and FIG. 9 operation 5 are examples of the operations of sub-block 1011. In some variants, the request for the list of RAN nodes in sub-block 1021 includes the identifier of the first cell. In some embodiments, the indication that the connection configuration is available (e.g., received in block 1020) includes respective addresses associated with the third RAN nodes, from which the connection configuration for the second RAN node can be obtained.

In some embodiments, the exemplary method can also include the operations of blocks 1050-1055, where the first RAN node can store the obtained connection configuration for the second RAN node (e.g., from block 1030) and send to the tracking node a connection configuration registration indicating that the first RAN node stores the connection configuration for the second RAN node. In some of these embodiments, the exemplary method can also include the operations of blocks 1060-1065, where after sending the connection configuration registration, the first RAN node can receive from a fourth RAN node a request for the connection configuration for the second RAN node and send the connection configuration for the second RAN node to the fourth RAN node. FIG. 8 operations 9 and 13 and FIG. 9 operations 10 and 14 are examples of the operations of blocks 1055-1065.

In some of these embodiments, the exemplary method can also include the following operations, labelled with corresponding block numbers:
(1070) receiving from the tracking node an update notification associated with the connection configuration for the second RAN node;
(1080) in response to the update notification, obtaining an updated connection configuration for the second RAN node from one of the third RAN nodes previously indicated by the tracking node; and
(1090) storing the updated connection configuration for the second RAN node.
   FIG. 8 operations 18-19 and FIG. 9 operations 18-19 are examples of the operations of blocks 1070-1080.

In some embodiments, the connection configuration for the second RAN node includes the following:
a first list of one or more RAN nodes that are blocked from establishing a connection with the second RAN node; and
a second list of one or more RAN nodes that are allowed to establish a connection with the second RAN node.

In some of these embodiments, the connection configuration for the second RAN node includes a third list of one or more RAN nodes that are blocked from using an established connection with the second RAN node for handover of UEs to target cells served by the second RAN node. In such embodiments, the exemplary method can also include the operations of block 1040, where the first RAN node can selectively establish a connection with the second RAN node based on the obtained connection configuration, which includes the following operations labelled with corresponding sub-block numbers:
(1041) initiating a connection setup with the second RAN node based on the following: the first RAN node is not a member of the first list or is a member of the second list, and the first RAN node is not a member of the third list; and
(1042) otherwise refraining from initiating a connection setup with the second RAN node.

In some embodiments, the tracking node does not serve any cells in the RAN and/or the tracking node does not store connection configurations for any nodes of the RAN. FIG. 8 shows an example of these embodiments, specifically the centralized connection configuration tracking architecture.

In other embodiments, one or more of the first, second, and third RAN nodes are configured to operate as tracking nodes (e.g., all RAN nodes). FIG. 9 shows an example of these embodiments, particularly for the decentralized or distributed connection configuration tracking architecture. In some of these embodiments, obtaining the information from the tracking node in block 1020 includes the following operations, labelled with corresponding sub-block numbers:
(1023) before identifying the first cell (e.g., in block 1010), receiving from the second RAN node a connection configuration registration including the following: an identifier of the second RAN node, a list of cells served by the second RAN node, including the first cell, and an indication that the second RAN node stores a configuration for connections to other nodes in the RAN; and
(1024) storing the received connection configuration registration.

In some of these embodiments, obtaining the connection configuration for the second RAN node in block 1030 includes the operations of sub-block 1031, where based on determining that the identified first cell is in the list of cells included in the stored connection configuration registration (i.e., from the second RAN node), the first RAN node can obtain the connection configuration for the second RAN node from the second RAN node. In other words, the first RAN node previously received a registration from the second RAN node that includes the cell list, so the first RAN node can obtain the connection configuration directly from the second RAN node based on determining that the received cell identifier is on the cell list registered by the second RAN node.

In other of these embodiments, obtaining the information from the tracking node in block 1020 includes the following operations, labelled with corresponding sub-block numbers:
(1025) sending a first query to one of the RAN nodes configured to operate as a tracking node, for a list of RAN nodes that store a connection configuration for a RAN node that serves the first cell;
(1026) based on receiving no response to the first query, sending a second query to another of the RAN nodes configured to operate as a tracking node, for a list of RAN nodes that store a connection configuration for a RAN node that serves the first cell; and
(1027) receiving the information from the other of the RAN nodes in response to the second query.

In these embodiments, the first RAN node is not aware of which RAN node holds a copy of the connection configuration for the second RAN node, so the first RAN node must query for it. In some variants, the order of the first and second queries is determined based on one or more of the following:
which of the queried RAN nodes is a closer peer node to the first RAN node; and
which of the queried RAN nodes has a direct communication interface to the first RAN node.

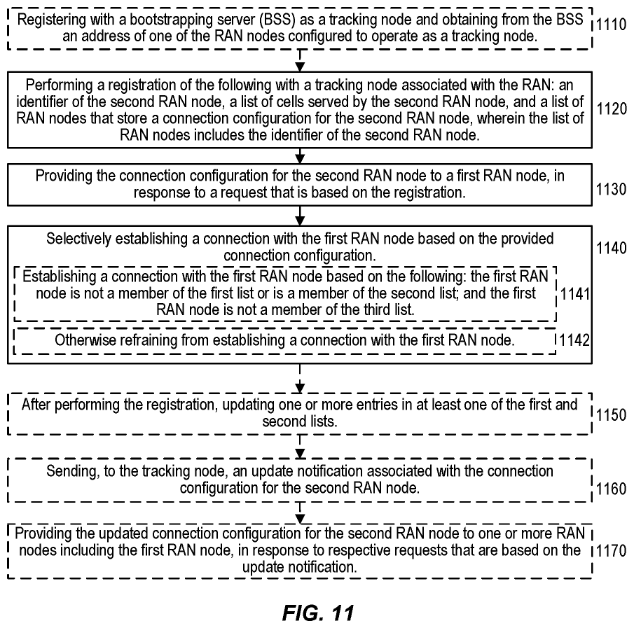

In addition, FIG. 11 (which includes FIGS. 11 A-B) illustrates an exemplary method (e.g., procedure) for a second RAN node configured to serve one or more cells, according to various embodiments of the present disclosure. The exemplary method shown in FIG. 11 can be performed by any appropriate RAN node (e.g., base station, eNB, gNB, ng-eNB, etc.) such as described elsewhere herein.

The exemplary method can include the operations of block 1120, where the second RAN node can perform a registration of the following with a tracking node associated with the RAN:
an identifier of the second RAN node,
a list of cells served by the second RAN node, and
a list of RAN nodes that store a connection configuration for the second RAN node, wherein the list of RAN nodes includes the identifier of the second RAN node.

The exemplary method can also include the operations of block 1130, where the second RAN node can subsequently provide the connection configuration for the second RAN node to a first RAN node, in response to a request that is based on the registration. The exemplary method can also include the operations of block 1140, where the second RAN node can selectively establish a connection with the first RAN node based on the provided connection configuration.

In some embodiments, the connection configuration for the second RAN node includes the following:
a first list of one or more RAN nodes that are blocked from establishing a connection with the second RAN node; and
a second list of one or more RAN nodes that are allowed to establish a connection with the second RAN node.

In some of these embodiments, the connection configuration for the second RAN node also includes a third list of one or more RAN nodes that are blocked from using an established connection with the second RAN node for handover of UEs to target cells served by the second RAN node. In such embodiments, selectively establishing the connection in block 1140 includes the following operations labelled with corresponding sub-block numbers:
(1141) establishing a connection with the first RAN node based on the following: the first RAN node is not a member of the first list or is a member of the second list, and the first RAN node is not a member of the third list; and
(1142) otherwise refraining from establishing a connection with the first RAN node.

In some of these embodiments, the exemplary method can also include the following operations, labelled with corresponding block numbers:
(1150) after performing the registration (e.g., in block 1120), updating one or more entries in at least one of the first and second lists;
(1160) sending, to the tracking node, an update notification associated with the connection configuration for the second RAN node; and
(1170) subsequently providing the updated connection configuration for the second RAN node to one or more RAN nodes including the first RAN node, in response to respective requests that are based on the update notification.

FIG. 8 operations 17-19 and FIG. 9 operations 17-19 are examples of operations 1150-1170 in FIG. 11.

In some embodiments, the tracking node does not serve any cells in the RAN and/or the tracking node does not store connection configurations for any nodes of the RAN. FIG. 8 shows an example of these embodiments, specifically the centralized connection configuration tracking architecture.

In other embodiments, one or more of the first, second, and third RAN nodes are configured to operate as tracking nodes (e.g., all RAN nodes). FIG. 9 shows an example of these embodiments, particularly for the decentralized or distributed connection configuration tracking architecture. In some of these embodiments, the exemplary method can also include the operations of block 1110, where the second RAN node can register with a bootstrapping server (BSS) as a tracking node and obtain from the BSS an address of one of the RAN nodes configured to operate as a tracking node, to which the registration is performed (e.g., in block 1120). FIG. 9 operation 3 is example of operation 1110 of FIG. 11.

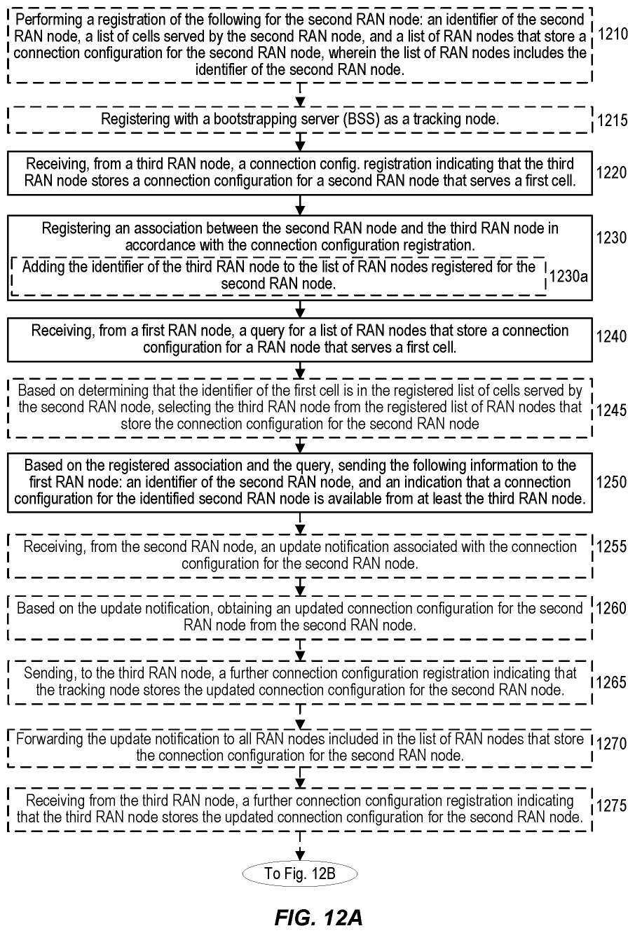

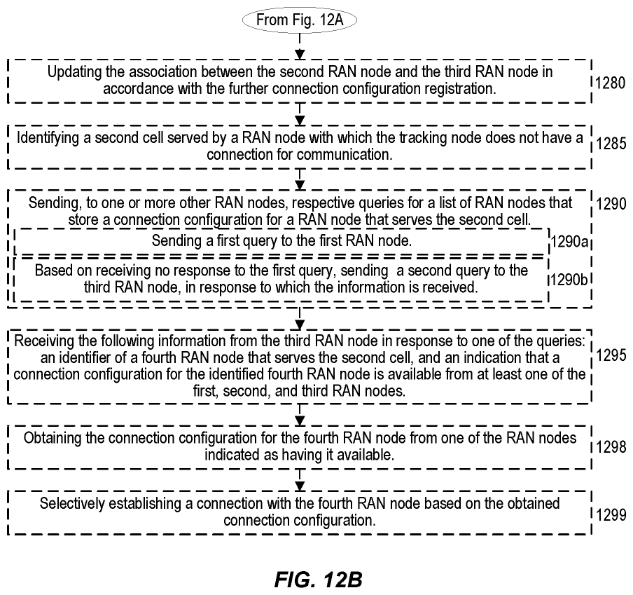

In addition, FIG. 12 (which includes FIGS. 12A-B) illustrates an exemplary method (e.g., procedure) for tracking node configured to track connection configurations for nodes of a RAN (e.g., NG-RAN), according to various embodiments of the present disclosure. For example, the exemplary method shown in FIG. 12 can be performed by a tracking node (e.g., base station, eNB, gNB, ng-eNB, CN node or NF, OAM node, host computing node, etc.) such as described elsewhere herein.

The exemplary method can include the operations of block 1220, where the tracking node can receive, from a third RAN node, a connection configuration registration indicating that the third RAN node stores a connection configuration for a second RAN node that serves a first cell. The exemplary method can also include the operations of block 1230, where the tracking node can register an association between the second RAN node and the third RAN node in accordance with the connection configuration registration. The exemplary method can also include the operations of block 1240, where the tracking node can subsequently receive, from a first RAN node, a query for a list of RAN nodes that store a connection configuration for a RAN node that serves a first cell. The exemplary method can also include the operations of block 1250, where based on the registered association, the tracking node can send the following information to the first RAN node: an identifier of the second RAN node, and an indication that a connection configuration for the identified second RAN node is available from at least the third RAN node.

In some embodiments, the exemplary method can also include the operations of block 1210, where the tracking node can perform a registration of the following for the second RAN node: an identifier of the second RAN node, a list of cells served by the second RAN node, and a list of RAN nodes that store a connection configuration for the second RAN node. The list of RAN nodes includes the identifier of the second RAN node. In some of these embodiments, the connection configuration registration includes an identifier of the third RAN node and registering the association between the second RAN node and the third RAN node in block 1230 includes the operations of sub-block 1231, where the tracking node can add the identifier of the third RAN node to the list of RAN nodes registered for the second RAN node.

In some of these embodiments, the query from the first RAN node includes an identifier of the first cell and the exemplary method also includes the operations of block 1245, where based on determining that the identifier of the first cell is in the registered list of cells served by the second RAN node, the tracking node can select the third RAN node from the registered list of RAN nodes that store the connection configuration for the second RAN node. The indication that the connection configuration is available (e.g., in block 1250) includes an address associated with the third RAN node, from which the connection configuration for the second RAN node can be obtained. In some variants, the indication that the connection configuration is available also includes an address associated with the second RAN node, from which the connection configuration for the second RAN node can be obtained.

In some embodiments, the exemplary method can also include the operations of block 1255, where the tracking node can receive, from the second RAN node, an update notification associated with the connection configuration for the second RAN node. Further variants of these embodiments are described below.

In some variants, the exemplary method can also include the following operations, labelled with corresponding block numbers:
(1270) forwarding the update notification to all RAN nodes included in the list of RAN nodes that store the connection configuration for the second RAN node;
(1275) receiving from the third RAN node, a further connection configuration registration indicating that the third RAN node stores the updated connection configuration for the second RAN node; and
(1280) updating the association between the second RAN node and the third RAN node in accordance with the further connection configuration registration.

FIG. 8 operations 18 and 20 are examples of operations 1270-1275. For example, in the centralized architecture of FIG. 8, the tracking node the tracking node does not serve any cells in the RAN and/or the tracking node does not store configurations for any cells in the RAN.

In other variants, the exemplary method can also include the following operations, labelled with corresponding block numbers:
(1260) based on the update notification, obtaining an updated connection configuration for the second RAN node from the second RAN node; and
(1265) sending, to the third RAN node, a further connection configuration registration indicating that the tracking node stores the updated connection configuration for the second RAN node.

FIG. 9 operations 19-20 are examples of operations 1260-1265. For example, in the distributed tracking architecture, the tracking node is a RAN node configured to serve one or more cells. In some of these variants, the exemplary method can also include the operations of block 1215, where the tracking node can register with a bootstrapping server (BSS) as a tracking node.

FIG. 9 operation 1a is example of operation 1215.

In some of these variants, the exemplary method can also include the following operations, labelled with corresponding block numbers:
(1285) identifying a second cell served by a RAN node with which the tracking node does not have a connection for communication;
(1290) sending, to one or more other RAN nodes, respective queries for a list of RAN nodes that store a connection configuration for a RAN node that serves the second cell; and
(1295) receiving the following information from the third RAN node in response to one of the queries: an identifier of a fourth RAN node that serves the second cell, and an indication that a connection configuration for the identified fourth RAN node is available from at least one of the first, second, and third RAN nodes.

In some of these variants, the respective queries in block 1290 include an identifier of the second cell, and sending the respective queries comprises the operations of sub-blocks 1290a-b, where the tracking node can send a first query to the first RAN node and based on receiving no response to the first query, send a second query to the third RAN node, in response to which the information is received in block 1295. In some further variants, the order of the first and second queries is determined based on one or more of the following:
which of the queried RAN nodes is a closer peer node to the tracking node; and
which of the queried RAN nodes has a direct communication interface to the tracking node.

In some of these variants, the exemplary method can also include the following operations, labelled with corresponding block numbers:
(1298) obtaining the connection configuration for the fourth RAN node from one of the RAN nodes indicated as having it available; and
(1299) selectively establishing a connection with the fourth RAN node based on the obtained connection configuration.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

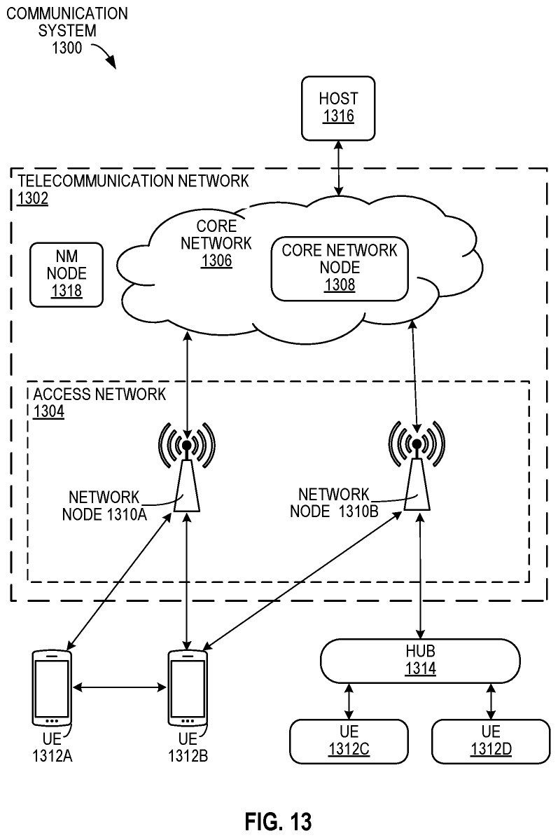

FIG. 13 shows an example of a communication system 1300 in accordance with some embodiments. In this example, the communication system 1300 includes a telecommunication network 1302 that includes an access network 1304, such as a RAN, and a core network 1306, which includes one or more core network nodes 1308. In some embodiments, telecommunication network 802 can also include one or more Network Management (NM) nodes 1318, which can be part of an operation support system (OSS) or a business support system (BSS). The NM nodes can monitor operations of other nodes in access network 1304 and core network 1306.

Access network 1304 includes one or more access network nodes, such as network nodes 1310a-b (one or more of which may be generally referred to as network nodes 1310), or any other similar 3GPP access node or non-3GPP access point. The network nodes 1310 facilitate direct or indirect connection of UEs, such as by connecting UEs 1312a-d (one or more of which may be generally referred to as UEs 1312) to the core network 1306 over one or more wireless connections.

In various embodiments, any of network node 1310, core network node 1308, NM node 1318, and host 1316 can be configured to perform operations attributed to a tracking node in the above descriptions of FIGS. 8-12.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310b. In other embodiments, the hub 1314 may be a non-dedicated hub—that is, a device which is capable of operating to route communications between the UEs and network node 1310b, but which is additionally capable of operating as a communication start and/or end point for certain data channels.

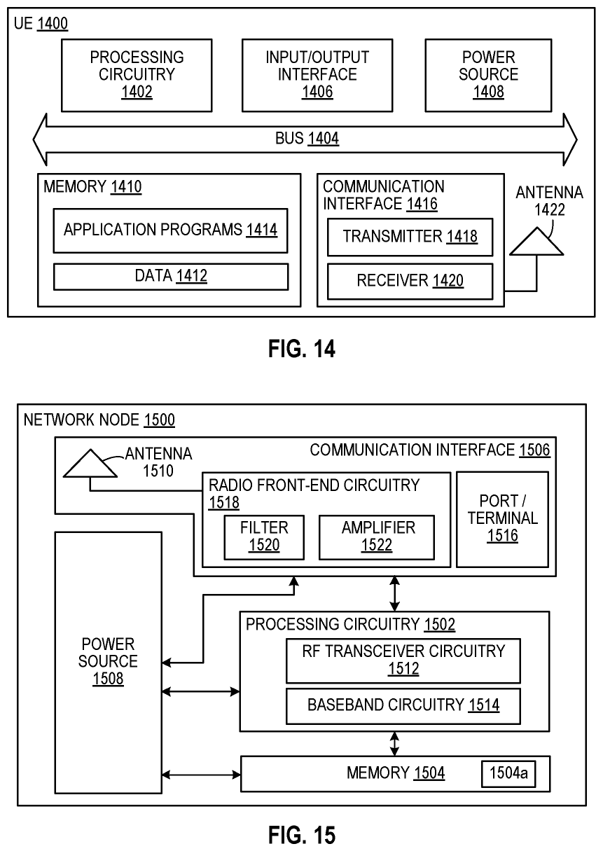

FIG. 14 shows a UE 1400 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions (collectively denoted computer program product 1504a) capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

Communication interface 1506 is used in wired or wireless communication of signaling and/or data between a network node, access network, and/or UE. As illustrated, communication interface 1506 comprises port(s)/terminal(s) 1516 to send and receive data, for example to and from a network over a wired connection. Communication interface 1506 also includes radio front-end circuitry 1518 that may be coupled to, or in certain embodiments a part of, antenna 1510. Radio front-end circuitry 1518 comprises filters 1520 and amplifiers 1522. Radio front-end circuitry 1518 may be connected to antenna 1510 and processing circuitry 1502. The radio front-end circuitry may be configured to condition signals communicated between antenna 1510 and processing circuitry 1502. Radio front-end circuitry 1518 may receive digital data that is to be sent out to other network nodes or UEs via a wireless connection. Radio front-end circuitry 1518 may convert the digital data into a radio signal having the appropriate channel and bandwidth parameters using a combination of filters 1520 and/or amplifiers 1522. The radio signal may then be transmitted via antenna 1510. Similarly, when receiving data, antenna 1510 may collect radio signals which are then converted into digital data by radio front-end circuitry 1518. The digital data may be passed to processing circuitry 1502. In other embodiments, the communication interface may comprise different components and/or different combinations of components.

In certain alternative embodiments, network node 1500 does not include separate radio front-end circuitry 1518, instead, processing circuitry 1502 includes radio front-end circuitry and is connected to antenna 1510. Similarly, in some embodiments, all or some of RF transceiver circuitry 1512 is part of communication interface 1506. In still other embodiments, communication interface 1506 includes one or more ports or terminals 1516, radio front-end circuitry 1518, and RF transceiver circuitry 1512, as part of a radio unit (not shown), and communication interface 1506 communicates with baseband processing circuitry 1514, which is part of a digital unit (not shown).

Antenna 1510 may include one or more antennas, or antenna arrays, configured to send and/or receive wireless signals. Antenna 1510 may be coupled to radio front-end circuitry 1518 and may be any type of antenna capable of transmitting and receiving data and/or signals wirelessly. In certain embodiments, antenna 1510 is separate from network node 1500 and connectable to network node 1500 through an interface or port.

Antenna 1510, communication interface 1506, and/or processing circuitry 1502 may be configured to perform any receiving operations and/or certain obtaining operations described herein as being performed by the network node. Any information, data and/or signals may be received from a UE, another network node and/or any other network equipment. Similarly, antenna 1510, communication interface 1506, and/or processing circuitry 1502 may be configured to perform any transmitting operations described herein as being performed by the network node. Any information, data and/or signals may be transmitted to a UE, another network node and/or any other network equipment.

Power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

As a specific example, network node 1500 can be configured to perform various operations attributed to a first RAN node, a second RAN node, or a tracking node in the above descriptions of FIGS. 8-12.

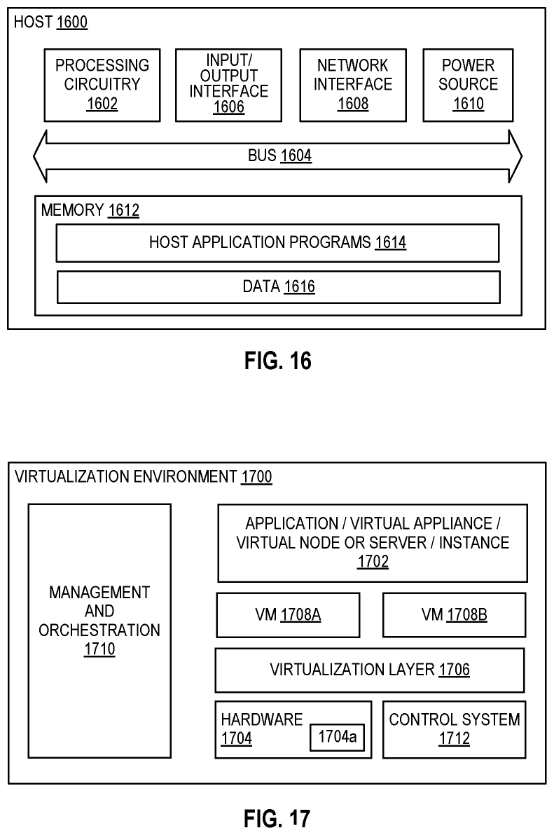

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

As a specific example, host 1600 can be configured to perform operations attributed to a tracking node in the above descriptions of FIGS. 8-12.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment 1700 to implement some of the features, functions, and/or benefits of some of the embodiments disclosed herein. As a specific example, the tracking node and any of the RAN nodes mentioned above in the descriptions of FIGS. 8-12 can be implemented as virtual nodes 1702 in virtualization environment 1700.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g., such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, etc., such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1.-54. (canceled)

55. A method for a first radio access network (RAN) node configured to serve one or more cells, the method comprising:
identifying a first cell served by a RAN node with which the first RAN node does not have a connection for communication;
in response to identifying the first cell, obtaining the following information from a tracking node associated with the RAN:
an identifier of a second RAN node that serves the first cell, and
an indication that a connection configuration for the identified second RAN node is available from one or more third RAN nodes; and
obtaining the connection configuration for the second RAN node from one of the indicated third RAN nodes.

56. The method of claim 55, wherein obtaining the information from the tracking node comprises:
sending to the tracking node a request for a list of RAN nodes that store a connection configuration for a RAN node that serves the first cell; and
receiving the information in response to the request.

57. The method of claim 55, wherein identifying the first cell comprises receiving, from a user equipment (UE) served by one of the cells, a measurement report comprising an identifier of the first cell.

58. The method of claim 55, wherein the indication that the connection configuration is available includes respective addresses associated with the third RAN nodes, from which the connection configuration for the second RAN node can be obtained.

59. The method of claim 55, further comprising:
storing the obtained connection configuration for the second RAN node;
sending, to the tracking node, a connection configuration registration indicating that the first RAN node stores the connection configuration for the second RAN node;
after sending the connection configuration registration, receiving from a fourth RAN node a request for the connection configuration for the second RAN node; and
sending the connection configuration for the second RAN node to the fourth RAN node.

60. The method of claim 55, further comprising:
receiving from the tracking node an update notification associated with the connection configuration for the second RAN node;
in response to the update notification, obtaining an updated connection configuration for the second RAN node from one of the third RAN nodes previously indicated by the tracking node; and
storing the updated connection configuration for the second RAN node.

61. The method of claim 55, wherein the connection configuration for the second RAN node includes the following:
a first list of one or more RAN nodes that are blocked from establishing a connection with the second RAN node; and
a second list of one or more RAN nodes that are allowed to establish a connection with the second RAN node.

62. The method of claim 61, wherein:
the connection configuration for the second RAN node includes a third list of one or more RAN nodes that are blocked from using an established connection with the second RAN node for handover of UEs to target cells served by the second RAN node; and
the method further comprises selectively establishing a connection with the second RAN node based on the obtained connection configuration, wherein selectively establishing the connection comprises:
initiating a connection setup with the second RAN node based on the following:
the first RAN node is not a member of the first list or is a member of the second list, and
the first RAN node is not a member of the third list; and
otherwise refraining from initiating a connection setup with the second RAN node.

63. The method of claim 55, wherein:
one or more of the first, second, and third RAN nodes are configured to operate as tracking nodes;
obtaining the information from the tracking node comprises:
before identifying the first cell, receiving from the second RAN node a connection configuration registration including the following:
an identifier of the second RAN node,
a list of cells served by the second RAN node, including the first cell, and
an indication that the second RAN node stores a configuration for connections to other nodes in the RAN; and
storing the received connection configuration registration; and
obtaining the connection configuration for the second RAN node comprises, based on determining that the identified first cell is in the list of cells included in the stored connection configuration registration, obtaining the connection configuration for the second RAN node from the second RAN node.

64. The method of claim 55, wherein:
one or more of the first, second, and third RAN nodes are configured to operate as tracking nodes; and
obtaining the information from the tracking node comprises:
sending a first query to one of the RAN nodes configured to operate as a tracking node, for a list of RAN nodes that store a connection configuration for a RAN node that serves the first cell;
based on receiving no response to the first query, sending a second query to another of the RAN nodes configured to operate as a tracking node, for a list of RAN nodes that store a connection configuration for a RAN node that serves the first cell; and
receiving the information from the other of the RAN nodes in response to the second query.

65. A method for a second radio access network (RAN) node configured to serve one or more cells, the method comprising:
performing a registration of the following with a tracking node associated with the RAN:
an identifier of the second RAN node,
a list of cells served by the second RAN node, and
a list of RAN nodes that store a connection configuration for the second RAN node, wherein the list of RAN nodes includes the identifier of the second RAN node;
subsequently providing the connection configuration for the second RAN node to a first RAN node, in response to a request that is based on the registration; and
selectively establishing a connection with the first RAN node based on the provided connection configuration.

66. The method of claim 65, wherein the connection configuration for the second RAN node includes the following:
a first list of one or more RAN nodes that are blocked from establishing a connection with the second RAN node; and
a second list of one or more RAN nodes that are allowed to establish a connection with the second RAN node.

67. The method of claim 66, wherein:
the connection configuration for the second RAN node also includes a third list of one or more RAN nodes that are blocked from using an established connection with the second RAN node for handover of user equipment (UEs) to target cells served by the second RAN node; and
selectively establishing the connection comprises:
establishing a connection with the first RAN node based on the following:
the first RAN node is not a member of the first list or is a member of the second list, and
the first RAN node is not a member of the third list; and
otherwise refraining from establishing a connection with the first RAN node.

68. The method of claim 66, further comprising:
after performing the registration, updating one or more entries in at least one of the first and second lists;
sending, to the tracking node, an update notification associated with the connection configuration for the second RAN node; and
subsequently providing the updated connection configuration for the second RAN node to one or more RAN nodes including the first RAN node, in response to respective requests that are based on the update notification.

69. The method of claim 65, wherein:
one or more nodes of the RAN are configured to serve one or more cells and to operate as tracking nodes; and
the method further comprises registering with a bootstrapping server (BSS) as a tracking node and obtaining from the BSS an address of one of the RAN nodes configured to operate as a tracking node, to which the registration is performed.

70. A method for a tracking node configured to track connection configurations for nodes of a radio access network (RAN) the method comprising:
receiving, from a third RAN node, a connection configuration registration indicating that the third RAN node stores a connection configuration for a second RAN node that serves a first cell;
registering an association between the second RAN node and the third RAN node in accordance with the connection configuration registration;
subsequently receiving, from a first RAN node, a query for a list of RAN nodes that store a connection configuration for a RAN node that serves a first cell; and
based on the registered association and the query, sending the following information to the first RAN node:
an identifier of the second RAN node, and
an indication that a connection configuration for the identified second RAN node is available from at least the third RAN node.

71. The method of claim 70, further comprising performing a registration of the following for the second RAN node:
an identifier of the second RAN node,
a list of cells served by the second RAN node, and
a list of RAN nodes that store a connection configuration for the second RAN node, wherein the list of RAN nodes includes the identifier of the second RAN node.

72. The method of claim 71, wherein:
the connection configuration registration includes an identifier of the third RAN node; and
registering the association between the second RAN node and the third RAN node comprises adding the identifier of the third RAN node to the list of RAN nodes registered for the second RAN node.

73. The method of claim 71, wherein:
the query from the first RAN node includes an identifier of the first cell;
the method further comprises, based on determining that the identifier of the first cell is in the registered list of cells served by the second RAN node, selecting the third RAN node from the registered list of RAN nodes that store the connection configuration for the second RAN node; and
the indication that the connection configuration is available includes one or more of the following:
an address associated with the third RAN node, from which the connection configuration for the second RAN node can be obtained; and
an address associated with the second RAN node, from which the connection configuration for the second RAN node can be obtained.

74. The method of claim 71, further comprising receiving, from the second RAN node, an update notification associated with the connection configuration for the second RAN node.

75. The method of claim 74, further comprising
based on the update notification, obtaining an updated connection configuration for the second RAN node from the second RAN node; and
sending, to the third RAN node, a further connection configuration registration indicating that the tracking node stores the updated connection configuration for the second RAN node.

76. The method of claim 74, further comprising:
forwarding the update notification to all RAN nodes included in the list of RAN nodes that store the connection configuration for the second RAN node;
receiving from the third RAN node, a further connection configuration registration indicating that the third RAN node stores the updated connection configuration for the second RAN node; and
updating the association between the second RAN node and the third RAN node in accordance with the further connection configuration registration.

77. The method of claim 70, wherein the tracking node is a RAN node configured to serve one or more cells and the method further comprises”
registering with a bootstrapping server, BSS, as a tracking node;
identifying a second cell served by a RAN node with which the tracking node does not have a connection for communication;
sending, to one or more other RAN nodes, respective queries for a list of RAN nodes that store a connection configuration for a RAN node that serves the second cell; and
receiving the following information from the third RAN node in response to one of the queries:
an identifier of a fourth RAN node that serves the second cell, and
an indication that a connection configuration for the identified fourth RAN node is available from at least one of the first, second, and third RAN nodes.

78. The method of claim 77, wherein the respective queries include an identifier of the second cell, and sending the respective queries comprises:
sending a first query to the first RAN node, and
based on receiving no response to the first query, sending a second query to the third RAN node, in response to which the information is received.

79. The method of claim 77, further comprising:
obtaining the connection configuration for the fourth RAN node from one of the RAN nodes indicated as having it available; and
selectively establishing a connection with the fourth RAN node based on the obtained connection configuration.

80. A first radio access network (RAN) node configured to serve one or more cells, the first RAN node comprising:
communication interface circuitry configured to communicate with one or more tracking nodes and with user equipment (UEs) via the one or more cells; and
processing circuitry operably coupled to the communication interface circuitry, wherein the processing circuitry and interface circuitry are configured to perform the method of claim 55.

81. A second radio access network (RAN) node configured to serve one or more cells, the second RAN node comprising:
communication interface circuitry configured to communicate with one or more tracking nodes and with user equipment (UEs) via the one or more cells; and
processing circuitry operably coupled to the communication interface circuitry, wherein the processing circuitry and interface circuitry are configured to perform the method of claim 65.

82. A tracking node configured to track connection configurations for radio access network (RAN) nodes, the tracking node comprising:
communication interface circuitry configured to communicate with the RAN nodes; and
processing circuitry operably coupled to the communication interface circuitry, wherein the processing circuitry and interface circuitry are configured to perform the method of claim 70.
